(19) United States
(12) Patent Application Publication
(10) Pub. No.: US 2025/0200844 A1
(43) Pub. Date: Jun. 19, 2025

(54) RENDERING DIGITAL VECTOR FILES WITH PRIORITIZED AND INCREMENTAL DOWNLOAD

(71) Applicant: Adobe Inc., San Jose, CA (US)

(72) Inventors: Deepak Kumar Sharma, Chhoti Sadri (IN); Ankur Krishna Gautam, Noida (IN); Angad Kumar Gupta, Noida (IN)

(21) Appl. No.: 18/538,186

(22) Filed: Dec. 13, 2023

(51) Int. Cl. G06T 11/60

(52) U.S. Cl. CPC G06T 11/60; G06T 2200/16

(57) ABSTRACT

The present disclosure relates to systems, non-transitory computer-readable media, and methods for prioritized downloading and rendering of digital vector file components. Specifically, in one or more embodiments, the disclosed systems determine, in connection with accessing a digital vector file, one or more artboards corresponding to one or more portions of a canvas area within the digital vector file. Additionally, the disclosed systems determine, by the at least one processor and for a selected artboard of the one or more artboards according to a download priority, a layer list comprising one or more components associated with the selected artboard. Further, the disclosed systems retrieve, for display, the selected artboard with the one or more components indicated in the layer list by accessing the one or more components associated with the selected artboard according to the download priority.

### BACKGROUND

Recent years have seen significant improvements in technology and software for creating and using intricate vector graphics in many different digital graphics environments. Specifically, vector-based graphics provide lossless scaling of images for achieving resolution independence, which is particularly useful in converting digital images to print or for use across many different types of media. Creating and manipulating vector graphics, however, can result in large files to store large amounts of digital data associated with vector-based image formats. To illustrate, a single digital vector file often has many different layers including many different anchor points, paths, and complex constructs such as repeats, gradient fills, clipping paths, compound paths, blending modes, etc., spanning across numerous artboards (or frames). Accordingly, managing such large digital vector files is an important, but often unwieldy, task given various constraints on computing and communication resources. Additionally, although conventional systems are capable of creating and manipulating large digital vector files, they have a number of technical deficiencies with regard to efficiently handling files with such complexity.

### SUMMARY

One or more embodiments provide benefits and/or solve one or more of the foregoing or other problems in the art with systems, non-transitory computer-readable media, and methods for prioritized downloading and rendering of digital vector file components. In particular, the disclosed systems generate, for each artboard of a digital vector file, a layers list including components overlapping with (or otherwise associated with) the artboard. Further, the disclosed systems insert the generated layers lists into a manifest for the digital vector file. Additionally, in some embodiments, the disclosed systems utilize a download priority of a digital vector file to select and download an artboard and its corresponding components in a specific order. To illustrate, the disclosed systems determine and download components corresponding to the selected artboard by accessing the layers list of the artboard in the manifest. Furthermore, the disclosed systems render the selected artboard and corresponding components in parallel with ongoing download of additional artboards and their corresponding components according to the download priority.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a prioritized rendering system operates in accordance with one or more embodiments.

FIG. 2 illustrates an overview of generating layer lists for prioritized download of artboards and corresponding components of a digital vector file in accordance with one or more embodiments.

FIG. 3 illustrates generating, and inserting into a manifest, layer lists for artboards of a digital vector file in accordance with one or more embodiments.

FIG. 4 illustrates initiating, in connection with accessing a digital vector file, a prioritized download of the digital vector file in accordance with one or more embodiments.

FIG. 5 illustrates a prioritized download of a digital vector file by downloading artboards and corresponding components according to a download priority in accordance with one or more embodiments.

FIG. 6 illustrates a diagram of an organization of a digital vector file in accordance with one or more embodiments.

FIGS. 7A and 7B illustrate graphical user interfaces for displaying artboards of a digital vector file according to a download priority in accordance with one or more embodiments.

FIG. 8 illustrates an example diagram of the prioritized rendering system in accordance with one or more embodiments.

FIG. 9 illustrates an example series of acts for prioritized downloading and rendering of digital vector file components in accordance with one or more embodiments.

FIG. 10 illustrates a block diagram of an example computing device for implementing one or more embodiments of the present disclosure.

### DETAILED DESCRIPTION

One or more embodiments of the present disclosure include a prioritized rendering system that prioritizes downloading and rendering of digital vector file artboards and corresponding components using artboard-specific layer lists. For example, the prioritized rendering system generates a digital vector file to include artboard-specific layer lists that include components corresponding to separate artboards of the digital vector file (e.g., layers, objects such as vector lines, shapes, and other elements, etc.). Further, the prioritized rendering system inserts the layers lists into a manifest corresponding to the digital vector file. Additionally, in some embodiments, the disclosed systems prioritize download of artboards of a digital vector file according to a download priority by leveraging layer lists for the artboards. For example, the disclosed systems parse a layer list of a selected artboard to determine components corresponding to the artboard. Furthermore, in one or more implementations, the disclosed systems render the downloaded artboard and corresponding components in parallel with ongoing downloads of additional artboards and corresponding components of the digital vector file according to the download priority.

As mentioned above, in some embodiments, the prioritized rendering system generates, for an artboard of a digital vector file, a layers list including components associated with the artboard. For example, the prioritized rendering system determines the components (e.g., layers or objects such as vector lines, shapes, and other elements, etc.) that overlap with at least a portion of the artboard area. The prioritized rendering system thus generates a layers list for each artboard that includes the components that overlap with at least a portion of the artboard area.

Further, as mentioned previously, the prioritized rendering system inserts generated layers lists for artboards of a digital vector file into a manifest for the digital vector file. Indeed, the prioritized rendering system stores for the digital vector file a manifest file describing the digital vector file and the attributes and components of the digital vector file. Accordingly, the prioritized rendering system inserts the generated layers lists into the manifest in response to generating the layer lists for storing with the digital vector file.

Additionally, as noted above, the prioritized rendering system downloads and renders one or more artboards of a digital vector file and their corresponding components according to a download priority. Specifically, the prioritized rendering system determines a download priority for downloading and rendering the artboards and corresponding components according to various criteria. For example, the prioritized rendering system selects, for initial download at a client device, the last active artboard from a previous session or an artboard having the smallest storage size. Furthermore, the prioritized rendering system utilizes a variety of factors for determining the download priority, such as the capability of the client device downloading and rendering the digital vector file, the network bandwidth, and/or cursor movements received from the client device.

Moreover, as mentioned above, the prioritized rendering system determines, for download with the determined artboard, components corresponding to the artboard by accessing the layers list for the artboard in the manifest. Indeed, after determining an artboard for prioritized download, the prioritized rendering system determines components corresponding to the artboard (e.g., components overlapping with a portion of the artboard area) by accessing the layers list for the artboard stored in the manifest. The prioritized rendering system downloads the components identified in the layer list for rendering the selected artboard at the client device.

Furthermore, in one or more implementations, the prioritized rendering system renders the downloaded artboard and corresponding components in parallel with ongoing downloads of additional artboards and corresponding components of the digital vector file according to the download priority. Indeed, the prioritized rendering system renders the downloaded artboard and corresponding components at a client device while continuing to download additional artboards and corresponding components. Further, the prioritized rendering system continues to determine additional artboards for prioritized download and rendering according to the download priority. In some embodiments, the prioritized rendering system determines corresponding components for download with the additional artboards via the layers list of each artboard. Thus, the prioritized rendering system continuously downloads artboards and corresponding components in parallel until the full digital vector file has been downloaded.

Although some conventional systems create and manipulate vector graphics, such systems have a number of problems in relation to accuracy and efficiency, and flexibility of operation. For instance, conventional systems conventional systems inefficiently access large and complex digital vector files. More specifically, conventional systems generally download all components of digital vector files prior to rendering any portion of the digital vector files. The inability to render the components individually before downloading all the components of the digital vector file results in inefficiencies of conventional systems, particularly as file size and complexity of digital vector files grow. Indeed, the time required to download the file is typically directly proportional to the size of the file. Thus, conventional systems use computing resources for longer than necessary, particularly in use cases involving mobile devices and/or devices with slow download speeds by not making any portion of downloaded files available more rapidly.

In addition to their inefficiencies, conventional systems inaccurately render objects belonging to different layers in some cases. Specifically, certain conventional systems download and render large digital vector files by incrementally downloading large files component by component. This component-wise approach to downloading large digital vector files, however, fails to maintain fidelity in complex design scenarios. For example, when conventional systems using this approach render objects belonging to different layers on overlapping artboards with screen blending, the results are often inaccurate. Indeed, the conventional systems sometimes display objects inaccurately because these systems cannot meaningfully determine the order in which the objects should be rendered.

Furthermore, conventional systems demonstrate operational inflexibility by lacking the ability to render large digital vector files according to differing pathways. For instance, some conventional systems do not include a mechanism for adjusting between pathways for incremental downloading and rendering of digital vector files. For example, even conventional systems that incrementally download large files component by component lack any mechanism for varying the order in which components are downloaded and rendered while maintaining accuracy.

As suggested by the foregoing, the prioritized rendering system provides a variety of technical advantages relative to conventional systems. For example, by prioritizing and parallelizing the tasks of downloading and rendering large digital vector files, the prioritized rendering system improves efficiency relative to conventional systems. Specifically, the prioritized rendering system frees up computing resources by making downloaded data available for rendering much more quickly. For example, the prioritized rendering system determines artboards and leverages layer lists including corresponding components of a digital vector file for prioritized downloading and rapid rendering. Further, the prioritized rendering system renders the downloaded data while continuing to download additional artboards and corresponding components according to the download priority of the prioritized rendering system. Thus, the prioritized rendering system renders the highest priority data in a shorter time, thereby freeing up valuable computing resources for users to view and interact with a digital vector file more quickly.

Furthermore, by prioritizing and downloading digital vector files incrementally in meaningful pieces (e.g., artboard by artboard), the prioritized rendering system improves accuracy relative to conventional systems. Specifically, in contrast to conventional systems that incrementally download a digital vector file component by component, the prioritized rendering system leverages layer lists to download and render a digital vector file beginning with specific artboards and corresponding components. By downloading and rendering artboards with corresponding components according to artboard-specific layer lists, the prioritized rendering system ensures that the data is accurately rendered. Indeed, the prioritized rendering system renders the objects accurately regardless of the order in which they are downloaded because the prioritized download system downloads and renders the digital vector file artboard by artboard.

Moreover, by determining a download priority with which to incrementally download and render portions of digital vector files, the prioritized rendering system improves flexibility relative to conventional systems. Specifically, by determining a download priority for artboards and leveraging corresponding layer lists, the prioritized rendering system determines varying pathways for incrementally downloading and rendering artboards and their corresponding components. For example, the prioritized rendering system determines a specific download priority based on a variety of factors including, by way of example and not limitation, the last artboard in use during a previous session, the file size of the artboards, the capability of the client device, the network bandwidth, and cursor movements received from the client device. Thus, by considering a variety of factors, the prioritized rendering system determines a variety of download priorities with which to proceed in determining artboards and corresponding components for prioritized incremental download.

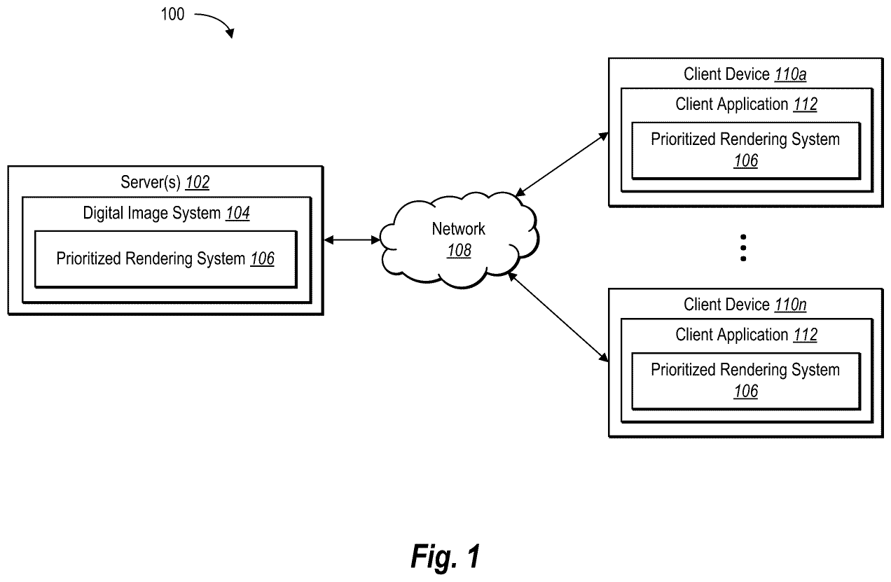

Additional detail regarding the height-based shadowing system will now be provided with reference to the figures. For example, FIG. 1 illustrates a schematic diagram of a system environment 100 in which a prioritized rendering system 106 operates. As illustrated in FIG. 1, the system environment 100 includes server(s) 102, a network 108, and client devices 110a-110n.

Although the system environment 100 of FIG. 1 is depicted as having a particular number of components, the system environment 100 is capable of having any number of additional or alternative components (e.g., any number of servers, client devices, or other components in communication with the prioritized rendering system 106 via the network 108). Similarly, although FIG. 1 illustrates a particular arrangement of the server(s) 102, the network 108, and the client devices 110a-110n, various additional arrangements are possible.

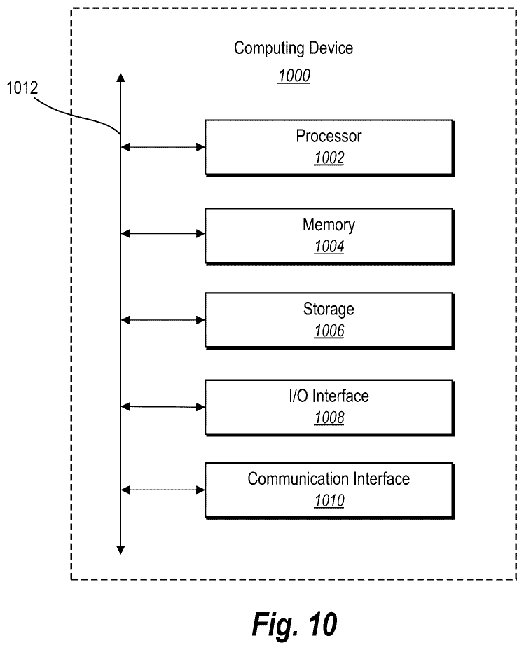

The server(s) 102, the network 108, and the client devices 110a-110n are communicatively coupled with each other either directly or indirectly (e.g., through the network 108 discussed in greater detail below in relation to FIG. 10). Moreover, the server(s) 102 and the client devices 110a-110n include one or more of a variety of computing devices (including one or more computing devices as discussed in greater detail with relation to FIG. 10).

As mentioned above, the system environment 100 includes the server(s) 102. In one or more embodiments, the server(s) 102 generates, stores, receives, and/or transmits data, including digital vector files and manifests associated therewith. In one or more embodiments, the server(s) 102 comprises a data server. In some implementations, the server(s) 102 comprises a communication server or a web-hosting server.

In one or more embodiments, the digital image system 104 provides functionality by which a client device (e.g., one of the client devices 110a-110n) generates, edits, manages, and/or stores digital vector files and manifests. For example, in some instances, a client device sends a digital vector file (e.g., a vector image) to the digital image system 104 hosted on the server(s) 102 via the network 108. The digital image system 104 stores the digital vector file for later access and/or modification by one or more client devices (e.g., the client devices 110a-110n). The digital image system 104 also provides various options to edit the digital vector file, store the digital vector file, and/or subsequently search for, access, and view the digital vector file

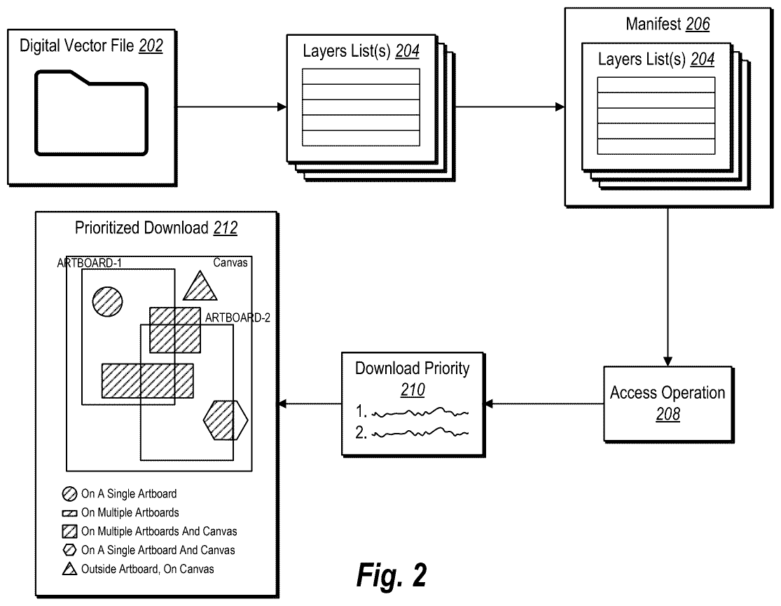

In one or more embodiments, the digital image system 104 utilizes the prioritized rendering system 106 to perform prioritized downloading and rendering of digital vector files for one or more client devices (e.g., the client devices 110a-110n). For example, the prioritized rendering system 106 determines a download priority associated with a digital vector file to determine one or more artboards to download and render while continuing to download the rest of the digital vector file. To illustrate, as discussed in further detail below with respect to FIGS. 2-9, the prioritized rendering system utilizes layer lists in a manifest for the digital vector file to download and render the digital vector file artboard by artboard (e.g., via parallel downloading and rendering of individual artboards and their components). Additionally, in one or more embodiments, the server(s) 102 provide generation of a digital vector file at a first client device (e.g., client device 110a) and prioritized download/rendering of the digital vector file at a second client device (e.g., client device 110n).

In one or more embodiments, the client devices 110a-110n include computing devices that display and/or modify digital vector files. For example, the client devices 110a-110n include one or more of smartphones, tablets, desktop computers, laptop computers, head-mounted-display devices, and/or other electronic devices. In some instances, the client devices 110a-110n include one or more applications (e.g., the client application 112) that display and/or modify digital vector files. For example, in one or more embodiments, the client application 112 includes a software application installed on the client devices 110a-110n for generating, viewing, or editing digital vector files. In additional embodiments, the client application 112 includes a web browser or other application that accesses a software application hosted on the server(s) 102 (and supported by the digital image system 104).

In one or more embodiments, the prioritized rendering system 106 and/or the digital image system 104 on the server(s) 102 supports the prioritized rendering system 106 on the client device 110n. For instance, in some cases, the server(s) 102 generates or otherwise provides the prioritized rendering system 106 for a client device (e.g., the client device 110n). The server(s) 102 provides the prioritized rendering system 106 to the client device 110n for performing prioritized downloading and rendering of digital vector files at the client device 110n. In other words, the client device 110n obtains (e.g., downloads) the prioritized rendering system 106 from the server(s) 102. Once downloaded, the client device 110n utilizes the prioritized rendering system 106 to render a digital vector file artboard by artboard in parallel with downloading the digital vector file independently from the server(s) 102.

In additional embodiments, although FIG. 1 illustrates the server(s) 102 and the client devices 110a-110n communicating via the network 108, the various components of the system environment 100 communicate and/or interact via other methods (e.g., the server(s) 10s and the client devices 110a-110n communicate directly). Furthermore, although FIG. 1 illustrates the prioritized rendering system 106 being implemented by a particular component and/or device within the system environment 100, the image difference captioning system 102 is implemented, in whole or in part, by other computing devices and/or components in the system environment 100. For example, in some embodiments, the server(s) 102 include or host the digital image system 104 and/or the prioritized rendering system 102.

To illustrate, the prioritized rendering system 106 includes a web hosting application that allows a client device (e.g., the client device 110n) to interact with content and services hosted on the server(s) 102. For example, in one or more implementations, the client device 110n accesses a software application (e.g., a web page) supported by the server(s) 102. In response, the prioritized rendering system 106 on the server(s) 102 performs operations for prioritized downloading and rendering of a digital vector file. The server(s) 102 then provides output or results of the operations to the client device 110n for display.

In one or more embodiments, the server(s) 102 include a variety of computing devices, including those described below with reference to FIG. 10. For example, the server(s) 102 include one or more servers for storing and processing data associated with digital vector files. In some embodiments, the server(s) 102 also include a plurality of computing devices in communication with each other, such as in a distributed storage environment. In some embodiments, the server(s) 102 include a content server. The server(s) 102 also optionally includes an application server, a communication server, a web-hosting server, a social networking server, a digital content campaign server, or a digital communication management server.

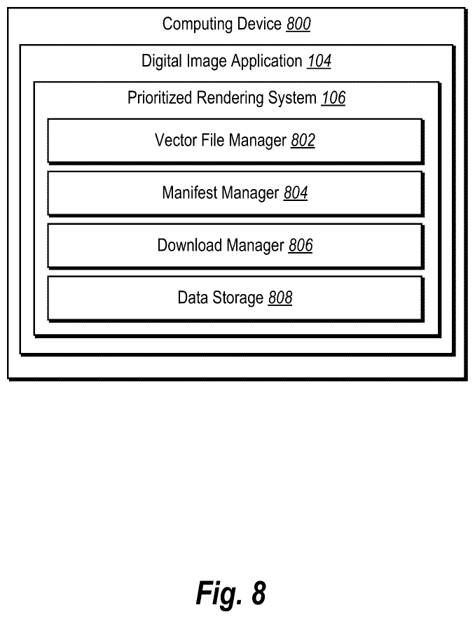

Indeed, the prioritized rendering system 106 is able to be implemented in whole, or in part, by the individual elements of the system environment 100. Indeed, although FIG. 1 illustrates the prioritized rendering system 106 implemented with regard to the server(s) 102, different components of the prioritized rendering system 106 are able to be implemented by a variety of devices within the system environment 100. For example, one or more (or all) components of the prioritized rendering system 106 are implemented by a different computing device (e.g., one of the client devices 110a-110n) or a separate server from the server(s) 102 hosting the digital image system 104. Indeed, as shown in FIG. 1, the client devices 110a-110n include the prioritized rendering system 106. Example components of the prioritized rendering system 106 will be described below with regard to FIG. 8.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 102 and the client devices 110a-110n communicate via the network using one or more communication platforms and technologies suitable for transporting data and/or communication signals, including any known communication technologies, devices, media, and protocols supportive of data communications, examples of which are described with reference to FIG. 10.

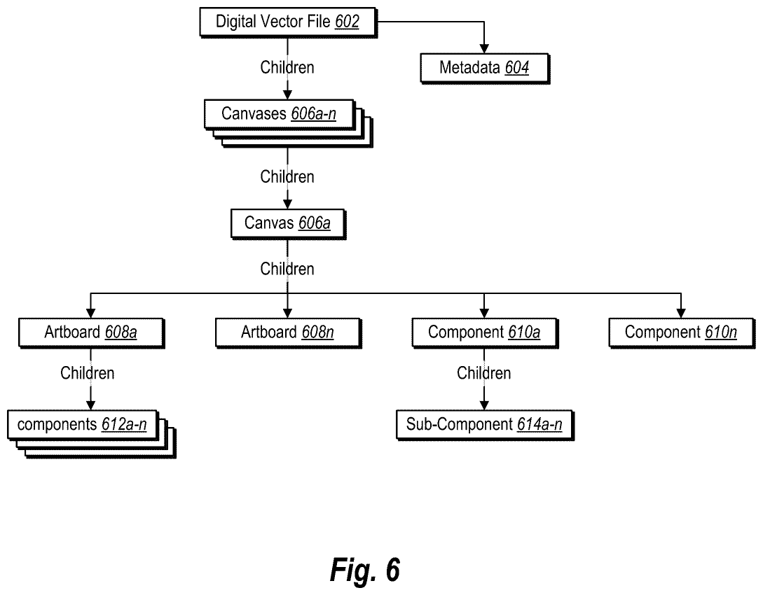

In one or more embodiments, a digital vector file includes a file or collection of files storing vector graphics in a digital storage environment. Specifically, a digital vector file includes vector graphics defined by mathematical equations indicating paths (e.g., curves or lines). Moreover, the mathematical equations of the vector graphics include equations describing properties of a path including, for example, path thickness, path pattern, and/or path color. Furthermore, in some implementations, the digital vector files are stored in a composite format (e.g., in a group of separate files that combine to produce one or more vector images together within a digital image application) as will be discussed in further detail with regard to FIG. 6.

As mentioned above, in some embodiments, the prioritized rendering system 106 downloads and renders digital vector file components according to a download priority. For example, FIG. 2 illustrates an overview of a process in which the prioritized rendering system 106 determines an order for downloading and rendering separate components of a digital vector file at a client device. To illustrate, FIG. 2 illustrates that the prioritized rendering system 106 performs operations to utilize layer lists for prioritized download of various artboards and their corresponding components of a digital vector file in accordance with one or more embodiments.

Specifically, the prioritized rendering system 106 generates, for one or more artboards of a digital vector file 202, layers list(s) 204 including components that overlap with the corresponding artboards of the digital vector file 202. Further, the prioritized rendering system 106 inserts the generated layers lists 204 into a manifest 206 corresponding to the digital vector file 202, as shown in FIG. 2. Additionally, the prioritized rendering system 106 performs an access operation 208 to download and render the digital vector file 202. Indeed, the prioritized rendering system 106 utilizes a download priority 210 to perform a prioritized download 212 of the digital vector file 202.

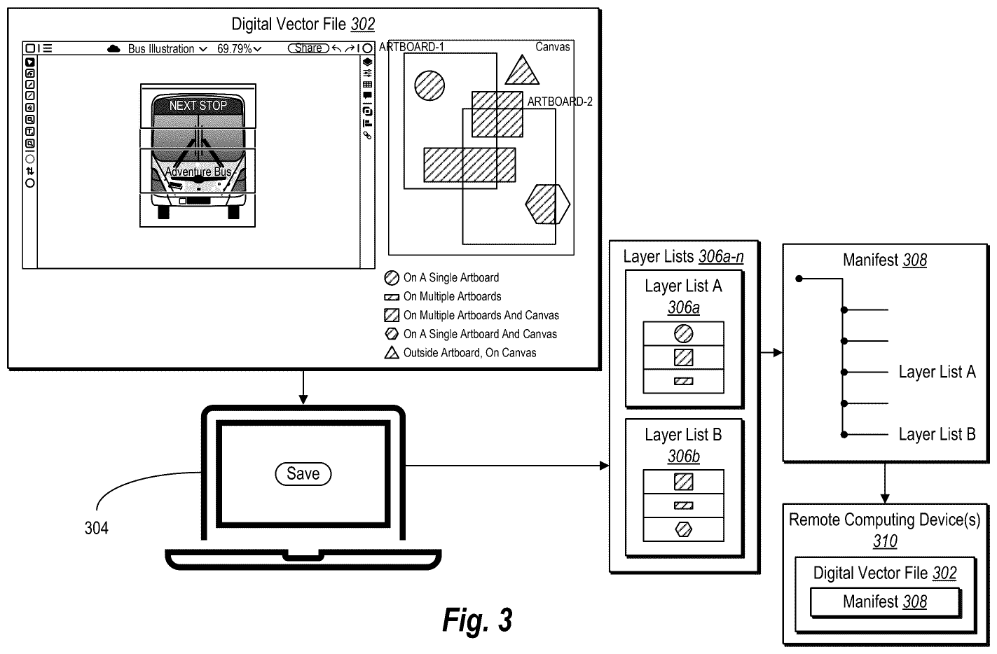

As mentioned above, the prioritized rendering system 106 generates, for each artboard of a digital vector file 202, a layers list 204 including the components associated with the artboard for insertion into the manifest 206 as will be discussed in further detail with regard to FIG. 3. For example, the prioritized rendering system 106 determines components such as layers and/or objects that overlap with at least a portion of an artboard area of an artboard. Indeed, the prioritized rendering system 106 determines objects such as paths, shapes, and other elements of the digital vector file that overlap with a portion of the artboard area for inclusion in the layers list 204 of an artboard.

Further, the prioritized rendering system 106 inserts the generated layers lists 204 into a manifest 206 for the digital vector file 202. Indeed, the prioritized rendering system 106 stores a manifest 206 file describing the digital vector file 202 and the attributes of the digital vector file 202. Moreover, the prioritized rendering system 106 generates the manifest to include the entire collection of individual components within the digital vector file 202. Indeed, in one or more implementations, the manifest combines the components of the digital vector file 202 together for storage in a composite format (e.g., by linking separate components and files to the digital vector file 202).

Additionally, the prioritized rendering system 106 inserts the generated layers list(s) 204 into the manifest 206 in response to generating the layer list(s) 204. In one or more embodiments, a layers list 204 includes an artboard-specific dataset storing information indicating components that overlap with an artboard. Further, in various implementations, the layers list 204 includes a generic format accessible by any application, which allows for interoperability of the layers list 204 across applications. In one or more embodiments, the prioritized rendering system 106 writes the identifiers of components in the layers list 204 for a given artboard to the manifest. Additionally, in embodiments where the digital vector file is stored in a composite format, the prioritized rendering system 106 appends the layers list 204 as an attribute to the artboard node in the composite digital vector file.

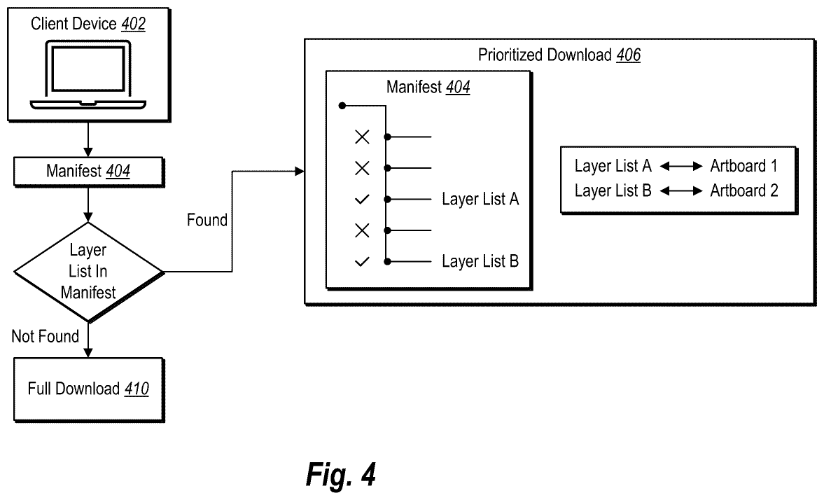

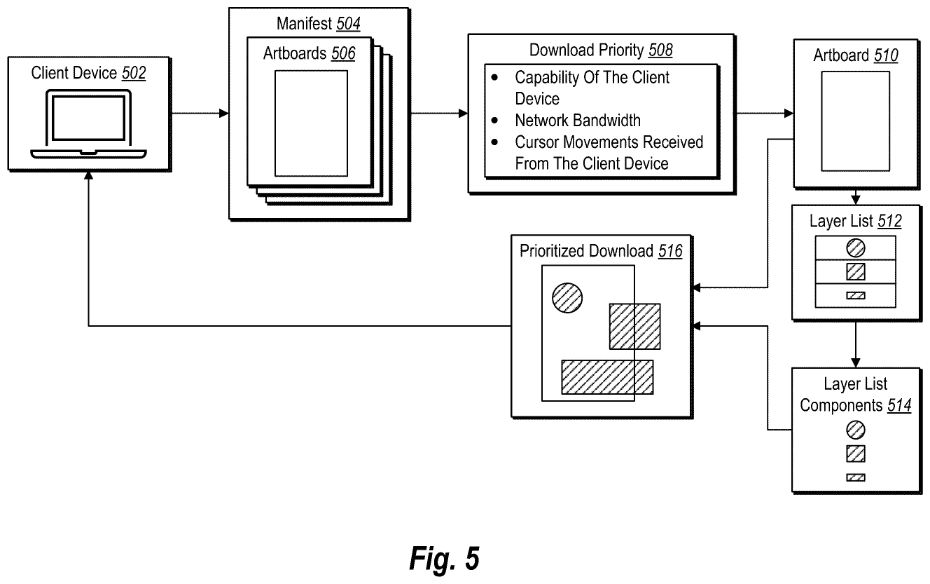

As mentioned previously, the prioritized rendering system 106 performs an access operation 208 to perform the prioritized download 212 of the digital vector file 202 according to a download priority 210 as will be discussed in further detail with regard to FIGS. 4 and 5. For example, in connection with opening the digital vector file 202, the prioritized rendering system 106 performs an access operation 208 to download and render the digital vector file 202. Indeed, the prioritized rendering system 106 utilizes a download priority 210 to perform a prioritized download 212 of the digital vector file 202.

For example, the download priority 210 includes an order in which the prioritized rendering system 106 downloads the artboards and corresponding components. Further, to determine the download priority 210, the prioritized rendering system 106 utilizes a variety of factors relating to the client device and the environment in which the client device is operating. Indeed, the prioritized rendering system 106 determines the download priority 210 by determining the capability of client factors such as available memory, processing speed, operating system, disk space, bus speed, etc. Further, the prioritized rendering system 106 also accounts for user interactions with downloaded and rendered artboards and corresponding components received from the application in determining the download priority 210. Moreover, the prioritized rendering system 106 also determines factors relating to the environment in which the client device operates such as download speeds of an internet connection, intermittency of an internet connection, etc.

In one or more embodiments, in response to determining the download priority 210, the prioritized rendering system 106 begins the prioritized download 212 of the digital vector file 202 as discussed further in regard to FIG. 5. For example, the prioritized rendering system 106 utilizes the download priority to determine an initial artboard for the prioritized download 212. Additionally, the prioritized rendering system 106 determines the components corresponding to the determined artboard in the layers list 204 of the determined artboard. In some implementations, the prioritized rendering system 106 then downloads the determined artboard and corresponding components. Further, the prioritized rendering system 106 renders the determined artboard and components in parallel with continuing to identify and download artboards and components of the digital vector file 202, as will be discussed further with regard to FIG. 5.

As mentioned above, in one or more implementations, the prioritized rendering system 106 generates, for each artboard of a digital vector file, a layers list including components associated with the artboard for insertion into a manifest. For example, FIG. 3 illustrates generating layer lists 306a-n for artboards of a digital vector file 302 and inserting the layer lists 306a-n into a manifest 308 of the digital vector file 302 in accordance with one or more embodiments. Specifically, the prioritized rendering system 106 generates the layer lists 306a-n for the artboards in response to an operation 304 of the prioritized rendering system 106. Further, the prioritized rendering system 106 inserts the generated layer lists 306a-n into the manifest 308 corresponding to the digital vector file 302. Moreover, the prioritized rendering system 106 stores the manifest 308 with the digital vector file 302 on one or more remote computing devices 310.

In one or more embodiments, a digital vector file includes a variety of components. For example, FIG. 3 illustrates a digital vector file 302 displayed in a graphical user interface (i.e., showing the school bus graphic) and a diagram representation thereof. Indeed, the diagram representation of the digital vector file 302 illustrates a canvas, artboards of the canvas (artboard-1 and artboard-2), and various shapes or objects in the artboards/canvas (representing certain components associated with the digital vector file 302 as discussed in further detail below). In some embodiments, the digital vector file 302 includes one or more canvases.

In some implementations, the canvas of the digital vector file 302 includes an unbounded two-dimensional cartesian coordinate space. Moreover, in these or other embodiments, the canvas provides a surface on which components of the digital vector file 302 are placed. To illustrate, the components are placed on the canvas through a variety of placement methods such as by being drawn, copied, or by other placement methods within a digital image application for generating or editing digital vector files.

Further, in one or more implementations, each canvas includes one or more artboards and/or one or more components. In some embodiments, an artboard is a sub-region (e.g., a rectangular portion) of a parent canvas. For example, an artboard includes data defining the size and location of the artboard within the coordinate system of the parent canvas. Moreover, the visual appearance of an artboard, when rendered at a client device, is impacted by content (e.g., paths or other objects) within the artboard or that corresponds to the canvas or another artboard and overlaps with the artboard.

Additionally, the shapes in the diagrammatic representation of the digital vector file 302 represent components (e.g., layers, objects, and other elements) associated with a canvas and artboards of the digital vector file 302. To illustrate, the shapes in the diagrammatic representation include a circle on artboard-1, a square overlapping both artboards and the canvas, a rectangle overlapping both artboards, a hexagon overlapping the canvas and artboard-2, and a triangle overlapping on the canvas. Although the diagrammatic representation includes various components, a digital vector file 302 includes any number of components in any number of artboards of a canvas.

As previously mentioned, in one or more embodiments, the prioritized rendering system 106 generates layer lists 306a-n for the artboards in response to an operation 304 of the prioritized rendering system 106. For example, the prioritized rendering system 106 generates layer list A 306a and layer list B 306b for artboard-1 and artboard-2, respectively, in response to the operation 304 of the prioritized rendering system 106. The prioritized rendering system 106 responds to any suitable operation of the prioritized rendering system 106, such as receiving a user interaction requesting that the digital vector file 302 be saved, as shown in FIG. 3, or in response to an automatic save of the digital vector file 302 by the prioritized rendering system 106, or other operation of the prioritized rendering system 106 (e.g., a load operation).

In some implementations, the prioritized rendering system 106 determines one or more components corresponding to (e.g., overlapping at least partially with) the artboards (e.g., artboards-1 and -2) within the canvas area for inclusion into the respective layer lists 306a-n for the artboards. Specifically, in one or more implementations, the prioritized rendering system 106 determines a boundary for each artboard that corresponds to a portion of the canvas area to determine which components overlap with the artboards. For example, the rectangles within the canvas area representing artboard-1 and artboard-2 illustrate the boundaries of these artboards.

Further, the prioritized rendering system 106 determines the components of the digital vector file 302 that overlap with an artboard by determining which components are at least partially within the boundary of the artboard. As shown in FIG. 3, for example, the prioritized rendering system 106 determines that each of the circle, square, and rectangle overlap at least partially with artboard-1 because each of these components are fully or partially within the artboard-1 boundary. The prioritized rendering system 106 generates layer list A 306a to include the circle, square, and rectangle as shown in FIG. 3. Likewise, the prioritized rendering system 106 determines that the square, the rectangle, and the hexagon overlap with artboard-2 and generates layer list B 306b including the square, the rectangle, and the hexagon. The prioritized rendering system 106 does not include the triangle in either layer list since the triangle is not within the boundary for either artboard-1 or artboard-2.

Further, as mentioned above, the prioritized rendering system 106 inserts the generated layer lists 306a-n into the manifest 308 corresponding to the digital vector file 302. For example, as shown in FIG. 3, the prioritized rendering system 106 inserts each of layer list A 306a and layer list B 306b into the manifest 308. The prioritized rendering system 106 inserts the layer list for each artboard into the manifest 308 by writing identifiers of each component to the manifest 308. For example, the prioritized rendering system 106 writes identifiers of layers, objects, and other elements corresponding to the artboard to the manifest 308 (e.g., to a specific section of the manifest 308 designated for layer lists). Indeed, if the circle on artboard-1 represents a layer on the artboard, the prioritized rendering system 106 writes an identifier of the layer circle layer to the manifest 308, along with identifiers of the other components to insert layer list A into the manifest 308.

Moreover, in some implementations, the prioritized rendering system 106 stores the digital vector file 302 and the manifest 308 corresponding to the digital vector file 302 on one or more remote computing devices 310. In these or other embodiments, the prioritized rendering system 106 stores the digital vector file 302 and the corresponding manifest 308 via a cloud computing environment such that the digital vector file 302 and the manifest 308 are stored on the one or more remote computing devices 310.

As mentioned previously, in some embodiments, in response to receiving a request to open a digital vector file, the prioritized rendering system 106 performs an access operation to download and render the digital vector file. For example, FIG. 4 illustrates initiating, in connection with accessing a digital vector file, a prioritized download 406 of a digital vector file in accordance with one or more embodiments. Specifically, when accessing the digital vector file (e.g., in response to receiving a request to access the digital vector file), the prioritized rendering system 106 accesses a manifest 404 corresponding to the digital vector file to determine whether the manifest 404 includes one or more layer lists. Further, the prioritized rendering system 106 proceeds to the prioritized download 406 of the digital vector file in response to determining that the manifest 404 includes one or more layer lists.

As just mentioned, the prioritized rendering system 106 accesses the manifest 404 to determine whether the manifest 404 includes one or more layer lists in connection with accessing the digital vector file. Indeed, the prioritized rendering system 106 parses the manifest 404 to perform a layer list check to determine whether the manifest 404 includes a layer list, such as by checking the metadata of the manifest 404 for a layer list indicator. If the prioritized rendering system 106 determines that the manifest 404 does not contain any layer list indicator, and therefore does not contain any layer lists, the prioritized rendering system 106 proceeds to a full download 410 of the digital vector file. In particular, the full download 410 causes the client device 402 to download all components of the digital vector file prior to rendering any of the components at the client device 402.

As mentioned above, the prioritized rendering system 106 continues to the prioritized download 406 of the digital vector file if the prioritized rendering system 106 determines that the manifest 404 includes a layer list. For example, when the prioritized rendering system 106 parses the manifest 404 to perform a layer list check and determines that the metadata of the manifest 404 includes a layer list indicator, the prioritized rendering system 106 initiates the prioritized download 406 of the digital vector file. Indeed, as shown in FIG. 4, the prioritized rendering system 106 determines that the manifest 404 includes the layer list A and the layer list B, possibly in addition to other components.

Further, the layer lists A and layer list B correspond to specific artboards as described above with respect to FIGS. 2 and 3. For example layer list A corresponds to artboard-1 and layer list B corresponds to artboard-2. Thus, the prioritized rendering system 106 initiates the prioritized download 406 by determining the artboards of the digital vector file and their corresponding layer lists. Additionally, the prioritized rendering system 106 determines a first artboard for download and rendering according to a download priority as discussed in further detail below with respect to FIG. 5.

As just mentioned, in some implementations, the prioritized rendering system 106 performs a prioritized download of the digital vector file in connection with accessing the digital vector file. For example, FIG. 5 illustrates a prioritized download 516 of a digital vector file by downloading artboards 506 and corresponding components according to a download priority 508 in accordance with one or more embodiments. Specifically, the prioritized rendering system 106 determines the artboards 506 of the digital vector file as indicated in the manifest 504 and selects an artboard 510 for a prioritized download 516 according to the download priority 508.

Further, the prioritized rendering system 106 determines the components corresponding to the selected artboard 510 for download with the artboard 510 according to a layer list 512 of the artboard 510. Moreover, the prioritized rendering system 106 downloads the artboard 510 and corresponding components before downloading additional artboards and components corresponding thereto. Furthermore, the prioritized rendering system 106 renders the downloaded artboard 510 at a client device 502 in parallel with downloading an additional artboard and components corresponding thereto according to the download priority 508.

As mentioned above, the prioritized rendering system 106 determines the artboards 506 of the digital vector file in the manifest 504 and selects an artboard 510 for the prioritized download 516 of the digital vector file according to the download priority 508. For example, the prioritized rendering system 106 determines the artboards 506 from the layer list 512 in the manifest 504 in connection with accessing the digital vector file and after parsing the manifest 504 to perform a layer list check as described above with respect to FIG. 4. Further, the prioritized rendering system 106 accesses and determines the artboards 506 of the digital vector file according to each canvas of one or more canvases of the digital vector file. For instance, the prioritized rendering system 106 determines which artboards 506 of the digital vector file correspond to one or more portions of a given canvas area. Moreover, the prioritized rendering system 106 determines a boundary of the canvas area within the digital vector file and determines which of the artboards 506 overlap with the canvas area by determining which of the artboards 506 are at least partially within the boundary of the canvas or based on a mapping between the artboard(s) and the canvas in the manifest 504.

Moreover, in response to determining the artboards 506 indicated by the manifest 504, the prioritized rendering system 106 determines the artboard 510 to download according to the download priority 508. For instance, the prioritized rendering system 106 determines the artboard 510 for first download in the prioritized download 516. Indeed, in some implementations, the artboard 510 in FIG. 5 represents the initial artboard in the download priority. Further, FIG. 5 illustrates a process that is repeated until all the artboards 506 of the digital vector file are downloaded and displayed such that after the download of the initial artboard, artboard 510 represents an additional artboard.

In one or more embodiments, the prioritized rendering system 106 utilizes a download priority 508 to determine an order in which to download the artboards 506 until the digital vector file is fully downloaded and displayed. In some implementations, the download priority 508 includes one or more algorithms and/or a variety of factors in determining the order in which to download the artboards of the digital vector file. Such factors include, by way of example, and not limitation, which artboard was in last use during a previous session, the file size of the artboards, the capability of the client device, network bandwidth, and cursor movements received from the client device.

For instance, in one or more embodiments, in response to the prioritized rendering system 106 determining that the client device 502 has a fast internet connection (e.g., above a threshold speed), the download priority 508 includes downloading the last active artboard from a previous session and corresponding components first, regardless of the storage size. Specifically, in these or other embodiments, the prioritized rendering system 106 determines the last active artboard in the previous session of a digital image application and an identification (ID) of the artboard. Further, the prioritized rendering system 106 assigns a high priority indicator to the artboard using the artboard ID. In some implementations, the high priority indicator indicates to the prioritized rendering system 106 that the artboard is the initial artboard in the download priority 508. In one or more implementations, the high priority indicator indicates that the artboard should be advanced in the download priority 508. For example, in some embodiments, the priority indicator indicates that the artboard should be the next artboard for download when the prioritized rendering system 106 has already initiated the prioritized download 516.

In another example, in response to the prioritized rendering system 106 determining that the client device 502 has a slow connection (e.g., below a threshold speed), the download priority 508 includes determining and downloading the artboard and components with the smallest storage size first. More specifically, the prioritized rendering system 106 selects artboards for downloading in sequence by storage size of the artboards and corresponding components due to the slow connection. In these or other embodiments, the prioritized rendering system 106 utilizes a similar mechanism of assigning a high priority indicator to the determined artboard as described above as part of determining the download priority 508.

In a further example, if the prioritized rendering system 106 receives, from the client device via the digital image application, a cursor movement interacting with a downloaded and rendered component overlapping with an artboard not yet downloaded, the prioritized rendering system 106 determines and advances the not yet downloaded artboard to the next download position in the download priority 508. Thus, the prioritized rendering system 106 determines the download priority 508 to prioritize artboards with which a user is most likely to interact next based on the cursor movements. Again, in these or other embodiments, the prioritized rendering system 106 utilizes the mechanism of assigning a high priority indicator to the artboard as described above. Further, the prioritized rendering system 106 then downloads the not yet downloaded artboard next according to the download priority 508.

Furthermore, in some embodiments, the prioritized rendering system 106 determines the components corresponding to the selected artboard 510 for download with the artboard 510. Indeed, the prioritized rendering system 106 determines the layer list 512 corresponding to the selected artboard 510 in the manifest 504 to determine the layer list components 514 associated with the artboard 510. For example, the prioritized rendering system 106 determines the layer list components 514 by extracting the layer list components 514 from the layer list 512. Accordingly, as discussed above, the prioritized rendering system 106 determines layers, objects, and/or other elements of the selected artboard 510 based on the layer list 512.

Moreover, in one or more embodiments, the prioritized rendering system 106 downloads the selected artboard 510 and corresponding layer list components 514 before downloading additional artboards and components corresponding thereto. Indeed, in response to determining the selected artboard 510 and the layer list components 514 corresponding thereto, the prioritized rendering system 106 initiates (or continues) the prioritized download 516 by downloading the artboard 510 and the layer list components 514 from one or more remote computing devices for rendering at the client device 502. Further, the prioritized rendering system 106 renders the artboard 510 and the corresponding layer list components 514 for display on the client device 502.

Furthermore, in some embodiments, the prioritized rendering system 106 renders the downloaded artboard 510 at the client device 502 in parallel with downloading additional artboards and components corresponding thereto according to the download priority 508. For example, the prioritized rendering system 106 uses the manifest 504 to determine an additional artboard and corresponding layer list for download in parallel with rendering the artboard 510 (which may be the initial artboard or a successive artboard) and the layer list components 514. Indeed, the prioritized rendering system 106 determines and downloads the additional artboard and corresponding layer list components according to the download priority 508 as described above with respect to the artboard 510 and the layer list components 514.

Moreover, the prioritized rendering system 106 downloads the additional artboard and corresponding layer list in parallel with rendering the artboard 510 and the layer list components 514 for display at the client device 502, thereby preserving time and valuable computing resources. Indeed, the prioritized rendering system 106 continues this process of determining and downloading additional artboards in parallel with rendering a prior downloaded artboard until all the artboards 506 associated with a canvas are downloaded and rendered at the client device 502. Furthermore, in some embodiments, the prioritized rendering system 106 continues this process for each canvas associated with the digital vector file until the entire digital vector file is downloaded and rendered at the client device 502.

In some implementations, the prioritized rendering system 106 is implemented at a server level. For example, the prioritized rendering system 106 at the server level retrieves artboards of the digital vector file and corresponding components for display within a digital image application. In these or other embodiments, the prioritized rendering system 106 performs similar processes at the server level for retrieving the artboards according to the download priority as discussed with respect to downloading the artboards for display on the client device 502. To illustrate, the prioritized rendering system 106 resides on an application server and determines artboards and corresponding components of the digital vector file to retrieve from a file server and transmit from the file server to the client device 502. In alternative embodiments, the prioritized rendering system 106 determines priority indicators for each of the artboards 506 of the digital vector file for display at a client device level. Indeed, in one or more embodiments, the prioritized rendering system 106 resides on the client device 502 and determines priority indicators for each of the artboards 506 of the digital vector file according to the download priority 508. Accordingly, the prioritized rendering system 106 at the client device 502 determines the download priority 508 and selects an artboard and corresponding layer list components and proceeds with the prioritized download 516. The prioritized rendering system 106 communicates with a file server including the digital vector file and retrieves the artboards and corresponding components in the prioritized download 516.

As just noted, in one or more embodiments, the prioritized rendering system 106 performs a prioritized download of a digital vector file for rendering at a client device. FIG. 6 illustrates an exemplary organization of a digital vector file 602 in accordance with one or more embodiments. In some implementations, the digital vector file 602 is stored in a composite format accessible by vector graphics applications. In these or other embodiments, the digital vector file 602 includes metadata 604, canvases 606a-n, artboards 608a-n (including components 612a-n), and components 610a-n (including sub-components 614a-n) as illustrated in FIG. 6. In one or more embodiments, components (e.g., components 610a-n, 612a-n, and subcomponents 614a-n) of the digital vector file 602 include a variety of elements. For example, the components include layers and/or objects such as paths, shapes, text, gradients, transformations, patterns, textures, and other elements typical of digital vector files.

Moreover, in some implementations, the digital vector file 602 is organized in a composite format as noted above. For example, the digital vector file 602 is organized such that the digital vector file 602 includes children canvases 606a-n and each canvas (e.g., canvas 606a) includes children artboards (e.g., children artboards 608a-n of canvas 606a) and components (e.g., children components 610a-n of canvas 606a). Further, in one or more implementations, each artboard includes children components (e.g., children components 612a-n of artboard 608a), each of which include children subcomponents (not shown). Additionally, each of the components 610a-n also include sub-components (e.g., children sub-components 614a-n of component 610a). Furthermore, in one or more implementations, any sub-components of the digital vector file may include children sub-components such that as many levels of children as needed are included according to the structure of the digital vector file.

Additionally, the digital vector file 602 includes metadata 604. The metadata 604 includes typical data about the digital vector file. Specifically, in some embodiments, the metadata 604 includes a manifest indicator identifying the manifest associated with the digital vector file 602. Indeed, the prioritized rendering system 106 utilizes the metadata 604 for a variety of functions. In one or more embodiments, the prioritized rendering system 106 identifies the manifest using the manifest indicator in the metadata 604 of the digital vector file 602. For instance, as discussed with respect to FIG. 5, the prioritized rendering system 106 uses the metadata 604 to access the manifest 504 corresponding to the digital vector file when determining the artboards 506 of the digital vector file for prioritized download 516.

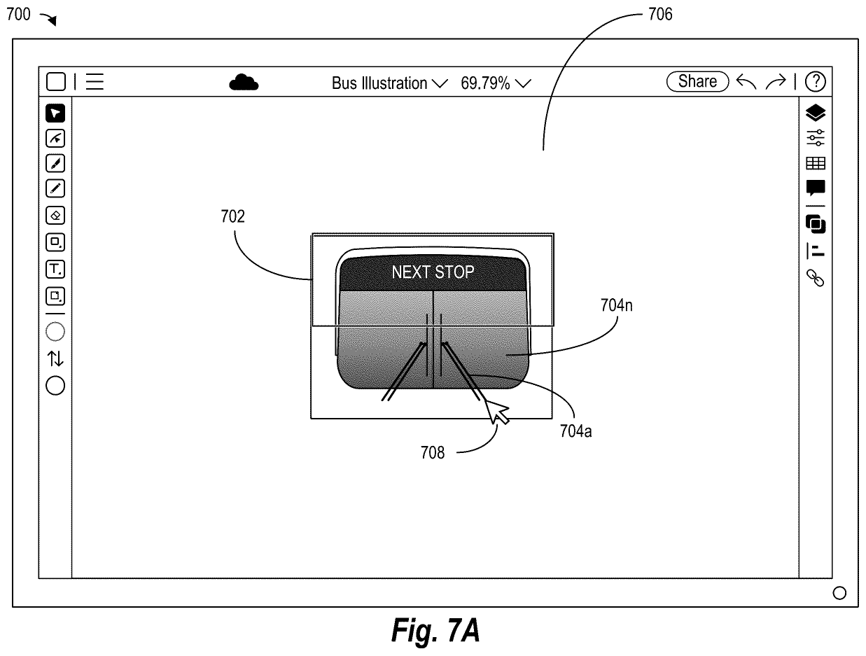

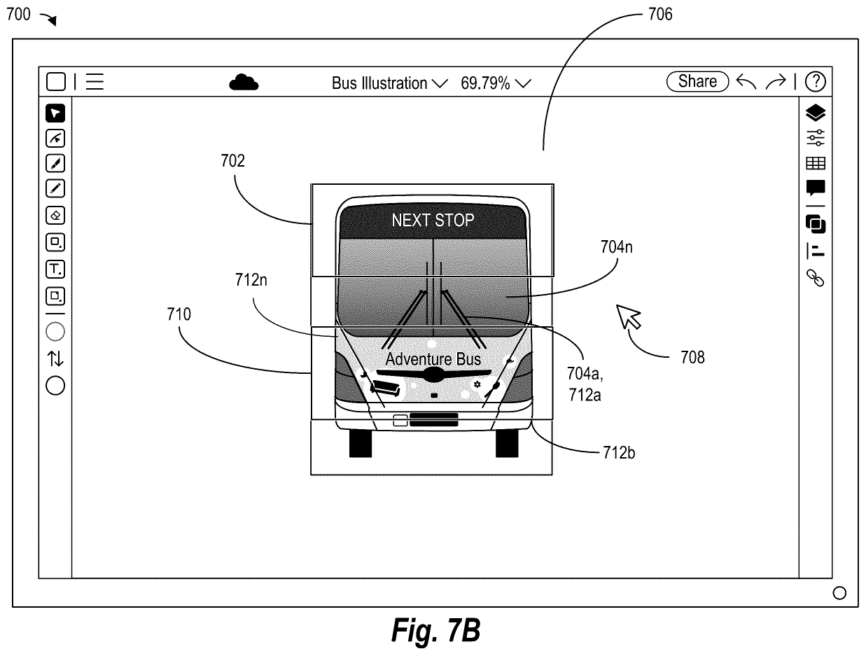

As discussed above, in one or more embodiments, the prioritized rendering system 106 performs a prioritized download of the artboards and corresponding components for display within the digital image application on a client device. For example, FIGS. 7A and 7B illustrate a graphical user interface 700 for displaying artboards according to a download priority in accordance with one or more embodiments. Specifically, FIG. 7A illustrates an initial artboard 702 and corresponding components 704a-n displayed in the graphical user interface 700 of the digital image application. Further, FIG. 7B illustrates an additional artboard 710 and corresponding components 712a-n rendered in the graphical user interface 700 of the digital image application according to a download priority.

In particular, in some embodiments, the prioritized rendering system 106 generates the graphical user interface 700 at the client device and renders the initial artboard 702 and corresponding components according to the download priority. As discussed previously with respect to FIG. 5, in some implementations, the prioritized rendering system 106 downloads and renders the initial artboard 702 at the client device according to a download priority wherein the prioritized rendering system 106 determines the download priority according to a variety of factors. Further, the prioritized rendering system 106 renders the initial artboard 702 and corresponding components 704a-n for display within the graphical user interface 700. Indeed, the prioritized rendering system 106 renders the component 704n (displayed as a windshield in the graphical user interface 700) and the component 704a, 712a (displayed as windshield wipers in the graphical user interface 700).

Additionally, in some implementations, the prioritized rendering system 106 determines an additional artboard and corresponding components for display utilizing the download priority. For instance, in one or more embodiments, the prioritized rendering system 106 utilizes an the download priority updated in response to receiving a cursor movement within the canvas area relative to an additional artboard and determines a layer list associated with the additional artboard. For example, as shown in FIG. 7A, the prioritized rendering system 106 receives a user input of a movement of a cursor 708 within the area of a canvas 706. Indeed, the prioritized rendering system 106 determines that the cursor 708 interacts with the component 704a, 712a (i.e., the component displaying the windshield wipers). In response to this cursor movement, the prioritized rendering system 106 determines, in the manifest, the additional layer list, which includes the component 704a, 712a and is associated with the additional artboard.

Turning now to FIG. 7B, the prioritized rendering system 106 downloads and renders the additional artboard 710 associated with the additional layer list along with the corresponding components 712b-n in the layer list. Indeed, the prioritized rendering system 106 advances the additional artboard 710 to the next download position in the download priority (e.g., based on the cursor movement). The prioritized rendering system 106 then downloads the additional artboard 710 and corresponding components 712b-n in parallel with rendering the initial artboard 702 and corresponding components 704a-n.

Further, the prioritized rendering system 106 renders the additional artboard 710 and corresponding components 712b-n for display within the graphical user interface 700. For example, the prioritized rendering system 106 renders a component 712b (displayed as the front bumper and tires of the bus) and a component 712n (displayed as the front grille panel of the bus). Moreover, the prioritized rendering system 106 renders the additional artboard 710 and corresponding components (712b-n) in parallel with downloading a further artboard and corresponding components (not shown). Thus, the prioritized rendering system 106 continues the prioritized incremental download of the digital vector file, artboard by artboard according to the download priority.

In some embodiments, the prioritized rendering system 106 begins downloading a third artboard (not shown) in parallel with rendering the initial artboard 702 before downloading the additional artboard 710. For example, the prioritized rendering system 106 begins downloading the third artboard prior to receiving the cursor movement and updating the download priority in response to the cursor movement. In these or other embodiments, the prioritized rendering system 106 advances the additional artboard 710 in the download priority for download in parallel with rendering the third artboard. Indeed, in some implementations, the prioritized rendering system 106 downloads and renders several artboards prior to receiving a cursor movement, which the prioritized rendering system 106 uses to update the download priority. Moreover, the prioritized rendering system 106 determines a variety of factors in establishing and updating the download priority as discussed above with regard to FIG. 5.

Turning to FIG. 8, additional detail will now be provided regarding various components and capabilities of the prioritized rendering system 106. In particular, FIG. 8 illustrates an example schematic diagram of a computing device 800 (e.g., the server(s) 102 and/or the client device(s) 110a-110n) implementing the prioritized rendering system 106 in accordance with one or more embodiments of the present disclosure for constituents 800-808. As illustrated in FIG. 8, the prioritized rendering system 106 includes a vector file manager 802, a manifest manager 804, a download manager 806, and data storage 808.

The vector file manager 802 accesses a digital vector file. For example, the vector file manager 802 accesses the digital vector file and determines one or more artboards associated with each canvas area within the digital vector file. Further, the vector file manager 802 determines one or more components associated with each artboard. Additionally, the vector file manager 802 generates a layer list including the one or more components associated with the artboard. Moreover, the vector file manager 802 interacts with other components to pass the layer list for further processing.

The manifest manager 804 receives the layer lists and inserts the layer lists into the manifest. For example, the manifest manager 804 receives the layer lists from the vector file manager 802. Further, the manifest manager 804 inserts the layer lists into the manifest corresponding to the digital vector file. Additionally, the manifest manager 804 accesses layer lists in the manifest and interacts with other constituents to pass the layer list to other constituents for further processes.

The download manager 806 manages the download priority and downloads the digital vector file according to the download priority. For example, the download manager 806 determines the download priority of the artboards for downloading and rendering the artboards associated with each canvas. Further, the download manager 806 selects an artboard for prioritized download according to the download priority and receives the associated layer list from the manifest manager 804. Additionally, the download manager 806 downloads the selected artboard and corresponding components according to the layer list of the selected artboard. Moreover, the download manager 806 renders the digital vector file for display within a digital image application or on a client device according to the download priority.

The data storage 808 (that includes a non-transitory computer memory) stores and maintains data associated with prioritized downloading and rendering of the digital vector files. . . . For example, the data storage 808 stores digital vector files, manifests, layer lists within the manifest, and algorithms associated with download priorities. Additionally, the data storage 808 stores data for rendering a digital vector file including layers, paths, objects, or other components of the digital vector file.

Each of the constituents 802-808 of the prioritized rendering system 106 can include software, hardware, or both. For example, the constituents 802-808 can include one or more instructions stored on a computer-readable storage medium and executable by processors of one or more computing devices, such as a client device or server device. When executed by the one or more processors, the computer-executable instructions of the prioritized rendering system 106 can cause the computing device(s) to perform the methods described herein.

Alternatively, the constituents 802-808 can include hardware, such as a special-purpose processing device to perform a certain function or group of functions. Alternatively, the constituents 802-808 of the prioritized rendering system 106 can include a combination of computer-executable instructions and hardware.

Furthermore, the constituents 802-808 of the prioritized rendering system 106 may, for example, be implemented as one or more operating systems, as one or more stand-alone applications, as one or more modules of an application, as one or more plug-ins, as one or more library functions or functions that may be called by other applications, and/or as a cloud-computing model. Thus, the constituents 802-808 of the prioritized rendering system 106 may be implemented as a stand-alone application, such as a desktop or mobile application. Furthermore, the constituents 802-808 of the prioritized rendering system 106 may be implemented as one or more web-based applications hosted on a remote server. Alternatively, or additionally, the constituents 802-808 of the prioritized rendering system 106 may be implemented in a suite of mobile device applications or “apps.” For example, in one or more embodiments, the prioritized rendering system 106 can comprise or operate in connection with digital software applications such as ADOBE® ILLUSTRATOR®, ADOBE® INDESIGN®, ADOBE® XD, and/or ADOBE® CREATIVE CLOUD®.

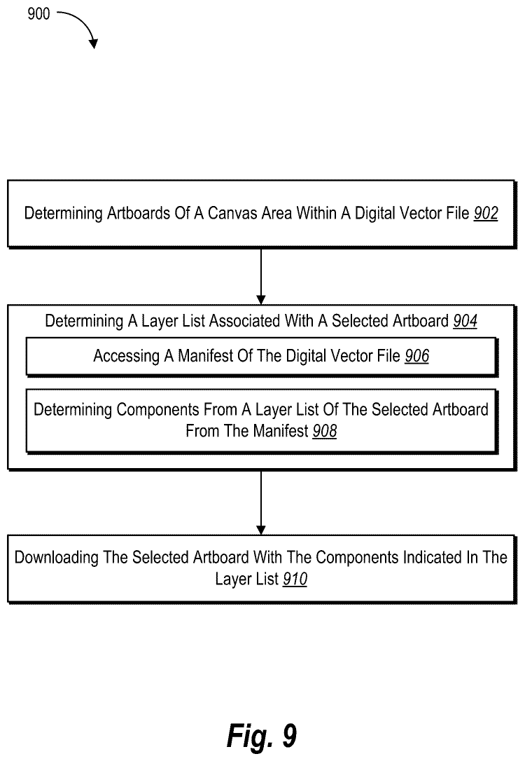

FIGS. 1-8, the corresponding text, and the examples provide a number of different systems, methods, and non-transitory computer readable media for prioritized downloading and rendering digital vector file artboards and corresponding components using artboard-specific layer lists. In addition to the foregoing, embodiments can also be described in terms of flowcharts comprising acts for accomplishing a particular result. For example, FIG. 9 illustrates a flowchart of an example sequence of acts in accordance with one or more embodiments.

While FIG. 9 illustrates acts according to some embodiments, alternative embodiments may omit, add to, reorder, and/or modify any of the acts shown in FIG. 9. The acts of FIG. 9 can be performed as part of a method. Alternatively, a non-transitory computer readable medium can comprise instructions, that when executed by one or more processors, cause a computing device to perform the acts of FIG. 9. In still further embodiments, a system can perform the acts of FIG. 9. Additionally, the acts described herein may be repeated or performed in parallel with one another or in parallel with different instances of the same or other similar acts.

As shown in FIG. 9, the series of acts 900 include an act 902 of determining artboards of a canvas area within a digital vector file. The series of acts 900 also includes an act 904 of determining a layer list associated with a selected artboard. Act 904 includes an act 906 of accessing a manifest of the digital vector file and an act 908 of determining components from a layer list of the selected artboard from the manifest. Additionally, the series of acts 900 includes an act 910 of downloading the selected artboard with the components indicated in the layer list.

For example, in one or more embodiments, the series of acts 900 includes determining, in connection with accessing a digital vector file, one or more artboards corresponding to one or more portions of a canvas area within the digital vector file. Further, the series of acts 900 includes determining, for a selected artboard of the one or more artboards according to a download priority, a layer list comprising one or more components associated with the selected artboard. Additionally, the series of acts 900 includes retrieving, for display, the selected artboard with the one or more components indicated in the layer list by accessing the one or more components associated with the selected artboard according to the download priority.

Moreover, in some embodiments, the series of acts 900 includes determining the download priority by determining a last active artboard from a previous session of a digital image application. Moreover, the series of acts 900 includes determining the download priority by determining an artboard identification of the last active artboard. Additionally, the series of acts 900 includes determining the download priority by assigning, utilizing the artboard identification, a high priority indicator to the last active artboard.

Further, in some implementations, the series of acts 900 includes determining the download priority by determining an artboard of the one or more artboards having a smallest storage size. Moreover, the series of acts 900 includes determining the download priority by determining an artboard identification of the artboard having the smallest storage size. Furthermore, the series of acts 900 includes determining the download priority by assigning, utilizing the artboard identification, a high priority indicator to the artboard having the smallest storage size based on the artboard identification.

In addition, in one or more embodiments, the series of acts 900 includes determining the download priority by selecting an initial artboard of the one or more artboards based on at least one of a capability of a client device corresponding to a digital image application, a network bandwidth, or cursor movements within the digital image application. Further, the series of acts 900 includes determining the download priority by determining an artboard identification of the initial artboard. Also, the series of acts 900 includes determining the download priority by assigning, utilizing the artboard identification, a high priority indicator to the initial artboard.

Furthermore, in some embodiments, determining the layer list comprises extracting the layer list from a manifest corresponding to the digital vector file. Additionally, in some implementations, determining the layer list comprising the one or more components associated with the selected artboard comprises determining, from the layer list, a component that at least partially overlaps an area of the selected artboard.

Moreover, in some embodiments, the series of acts 900 includes determining that a component of the one or more components associated with the selected artboard overlaps with an additional artboard within the digital vector file. Additionally, the series of acts 900 includes determining an additional layer list comprising one or more additional components associated with the additional artboard. Furthermore, the series of acts 900 includes retrieving, for display within a digital image application, the additional artboard with the one or more additional components indicated in the additional layer list.

In addition, in some implementations, the series of acts 900 includes determining a cursor movement within the canvas area relative to an additional artboard within the digital vector file. Further, the series of acts 900 includes determining, in response to the cursor movement, an additional layer list comprising one or more additional components associated with the additional artboard. Moreover, the series of acts 900 includes retrieving, for display within a digital image application, the additional artboard with the one or more additional components indicated in the additional layer list.

Furthermore, in some embodiments, the series of acts 900 includes determining, in connection with accessing a digital vector file, a layer list comprising components associated with an initial artboard of a canvas area within the digital vector file by accessing, for the digital vector file, a manifest comprising a set of components of the digital vector file. Additionally, the series of acts 900 includes determining a layer list comprising components associated with an initial artboard of a canvas area within the digital vector file by determining, from the set of components of the digital vector file, one or more components associated with the initial artboard as indicated in the layer list of the initial artboard. Moreover, the series of acts 900 includes determining a layer list comprising components associated with an initial artboard of a canvas area within the digital vector file by retrieving, for display within the digital image application, the digital vector file according to a download priority of the digital vector file by accessing the one or more components indicated in the layer list of the initial artboard.

In one or more implementations, the series of acts 900 includes providing the digital vector file according to the download priority by determining priority indicators of one or more artboards of the digital image application. Further, the series of acts 900 includes providing the digital vector file according to the download priority by selecting, based on the priority indicators, an artboard of the one or more artboards for initial rendering. Additionally, the series of acts 900 includes providing the digital vector file according to the download priority by retrieving, for display withing the digital image application, the selected artboard.

Moreover, in some embodiments, the series of acts 900 includes selecting an additional artboard associated with the digital vector file and one or more additional components associated with the additional artboard for download in parallel with rendering the initial artboard. In addition, in some implementations, the series of acts 900 includes determining the layer list by extracting one or more layers indicated by the layer list in the manifest. Furthermore, in some embodiments, the series of acts 900 includes determining the one or more components associated with the initial artboard by determining, from the layer list, one or more vector objects or one or more layers that at least partially overlap with an area of the initial artboard.

In some implementations, the series of acts 900 includes parsing the manifest to perform a layer list chick check to determine that the manifest comprises the layer list of the initial artboard. Furthermore, the series of acts 900 includes determining the one or more components associated with the initial artboard in response to determining that the manifest comprises the layer list.

Moreover, in some embodiments, the series of acts 900 includes determining one or more components overlapping at least partially with an artboard corresponding to a portion of a canvas area within a digital vector file. Also, the series of acts 900 includes generating, for the artboard, a layer list comprising the one or more components overlapping at least partially with the artboard. Furthermore, the series of acts 900 includes inserting the layer list of the artboard into a manifest corresponding to the digital vector file, the manifest indicating one or more components of the digital vector file.

In addition, in some implementations, the series of acts 900 includes selecting, in connection with accessing the digital vector file, the artboard according to a download priority. Moreover, the series of acts 900 includes retrieving, for display within a digital image application, the one or more components of the layer list of the artboard by accessing the layer list from the manifest corresponding to the digital vector file to render the artboard within the digital image application. Furthermore, in some embodiments, the series of acts 900 includes determining, from the manifest and according to the download priority, an additional layer list comprising one or more additional components associated with an additional artboard of the digital vector file. Additionally, the series of acts 900 includes retrieving, for display within the digital image application, the one or more additional components associated with the additional artboard in parallel with rendering the artboard within the digital image application. In one or more implementations, the series of acts 900 includes selecting the additional artboard for accessing from the digital vector file in parallel with rendering the artboard within the digital image application in response to interactions within the canvas area relative to the additional artboard.

Moreover, in some embodiments, determining the one or more components overlapping at least partially with the artboard comprises determining, for the artboard, a boundary corresponding to the portion of the canvas area. Further, the series of acts 900 includes determining that the one or more components are at least partially within the boundary corresponding to the portion of the canvas area.

In addition, in some implementations, inserting the layer list of the artboard into the manifest comprises writing, to the manifest, one or more layer identifiers of one or more layers of the digital vector file that overlap at least partially with the artboard.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium.

Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 (e.g., the server(s) 102 and/or the client devices 110a-n) that may be configured to perform one or more of the processes described above. One will appreciate that server(s) 102 and/or the client devices 110a-n may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining, in connection with accessing a digital vector file, one or more artboards corresponding to one or more portions of a canvas area within the digital vector file;
determining, for a selected artboard of the one or more artboards according to a download priority, a layer list comprising one or more components associated with the selected artboard; and
retrieving, for display, the selected artboard with the one or more components indicated in the layer list by accessing the one or more components associated with the selected artboard according to the download priority.

2. The computer-implemented method of claim 1, further comprising determining the download priority by:
determining a last active artboard from a previous session of a digital image application;
determining an artboard identification of the last active artboard; and
assigning, utilizing the artboard identification, a high priority indicator to the last active artboard.

3. The computer-implemented method of claim 1, further comprising determining the download priority by:
determining an artboard of the one or more artboards having a smallest storage size;
determining an artboard identification of the artboard having the smallest storage size; and
assigning, utilizing the artboard identification, a high priority indicator to the artboard having the smallest storage size based on the artboard identification.

4. The computer-implemented method of claim 1, further comprising determining the download priority by:
selecting an initial artboard of the one or more artboards based on at least one of a capability of a client device corresponding to a digital image application, a network bandwidth, or cursor movements within the digital image application;
determining an artboard identification of the initial artboard; and
assigning, utilizing the artboard identification, a high priority indicator to the initial artboard.

5. The computer-implemented method of claim 1, wherein determining the layer list comprises extracting the layer list from a manifest corresponding to the digital vector file.

6. The computer-implemented method of claim 1, wherein determining the layer list comprising the one or more components associated with the selected artboard comprises determining, from the layer list, a component that at least partially overlaps an area of the selected artboard.

7. The computer-implemented method of claim 1, further comprising:
determining that a component of the one or more components associated with the selected artboard overlaps with an additional artboard within the digital vector file;
determining an additional layer list comprising one or more additional components associated with the additional artboard; and
retrieving, for display within a digital image application, the additional artboard with the one or more additional components indicated in the additional layer list.

8. The computer-implemented method of claim 1, further comprising:
determining a cursor movement within the canvas area relative to an additional artboard within the digital vector file;
determining, in response to the cursor movement, an additional layer list comprising one or more additional components associated with the additional artboard; and
retrieving, for display within a digital image application, the additional artboard with the one or more additional components indicated in the additional layer list.

9. A system comprising:
one or more memory devices comprising a digital image application; and
one or more processors configured to cause the system to:
determine, in connection with accessing a digital vector file, a layer list comprising components associated with an initial artboard of a canvas area within the digital vector file by:
accessing, for the digital vector file, a manifest comprising a set of components of the digital vector file; and
determining, from the set of components of the digital vector file, one or more components associated with the initial artboard as indicated in the layer list of the initial artboard; and
retrieve, for display within the digital image application, the digital vector file according to a download priority of the digital vector file by accessing the one or more components indicated in the layer list of the initial artboard.

10. The system of claim 9, wherein the one or more processors are further configured to provide the digital vector file according to the download priority by:
determining priority indicators of one or more artboards of the digital image application;
selecting, based on the priority indicators, an artboard of the one or more artboards for initial rendering; and
retrieving, for display within the digital image application, the selected artboard.

11. The system of claim 9, wherein the one or more processors are further configured to select an additional artboard associated with the digital vector file and one or more additional components associated with the additional artboard for download in parallel with rendering the initial artboard.

12. The system of claim 9, wherein the one or more processors are further configured to determine the layer list by extracting one or more layers indicated by the layer list in the manifest.

13. The system of claim 9, wherein the one or more processors are further configured to determine the one or more components associated with the initial artboard by determining, from the layer list, one or more vector objects or one or more layers that at least partially overlap with an area of the initial artboard.

14. The system of claim 9, wherein the one or more processors are further configured to:
parse the manifest to perform a layer list check to determine that the manifest comprises the layer list of the initial artboard; and
determine the one or more components associated with the initial artboard in response to determining that the manifest comprises the layer list.

15. A non-transitory computer readable medium storing executable instructions which, when executed by a processing device, cause the processing device to perform operations comprising:
determining one or more components overlapping at least partially with an artboard corresponding to a portion of a canvas area within a digital vector file;
generating, for the artboard, a layer list comprising the one or more components overlapping at least partially with the artboard; and
inserting the layer list of the artboard into a manifest corresponding to the digital vector file, the manifest indicating one or more components of the digital vector file.

16. The non-transitory computer readable medium of claim 15, wherein the operations further comprise:
selecting, in connection with accessing the digital vector file, the artboard according to a download priority; and
retrieving, for display within a digital image application, the one or more components of the layer list of the artboard by accessing the layer list from the manifest corresponding to the digital vector file to render the artboard within the digital image application.

17. The non-transitory computer readable medium of claim 16, wherein the operations further comprise:
determining, from the manifest and according to the download priority, an additional layer list comprising one or more additional components associated with an additional artboard of the digital vector file; and
retrieving, for display within the digital image application, the one or more additional components associated with the additional artboard in parallel with rendering the artboard within the digital image application.

18. The non-transitory computer readable medium of claim 17, wherein the operations further comprise selecting the additional artboard for accessing from the digital vector file in parallel with rendering the artboard within the digital image application in response to interactions within the canvas area relative to the additional artboard.

19. The non-transitory computer readable medium of claim 15, wherein determining the one or more components overlapping at least partially with the artboard comprises:
determining, for the artboard, a boundary corresponding to the portion of the canvas area; and
determining that the one or more components are at least partially within the boundary corresponding to the portion of the canvas area.

20. The non-transitory computer readable medium of claim 15, wherein inserting the layer list of the artboard into the manifest comprises writing, to the manifest, one or more layer identifiers of one or more layers of the digital vector file that overlap at least partially with the artboard.
